(19) United States
(12) Patent Application Publication
(10) Pub. No.: US 2005/0191042 A1
(43) Pub. Date: Sep. 1, 2005

(54) Data recording control method and apparatus capable of adding playlist during recording of data in video format in optical recording medium

(75) Inventor: Sang-Am Lee, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/041,365

(22) Filed: Jan. 25, 2005

(30) Foreign Application Priority Data
Feb. 26, 2004 (KR) 2004-13070

(51) Int. Cl. H04N 5/781

(52) U.S. Cl. 386/125; 386/126

(57) ABSTRACT

A record control method enables additional recording of one or more playlists when image data is recorded onto an optical recording medium in a video format. The record control method comprises recording the image data onto the optical recording medium in the unit of titles, designating a predetermined interval in the recorded title, constructing a playlist with information about the designated predetermined interval, and recording the constructed playlist in a predetermined location of the optical recording medium. Accordingly, a playlist can be constructed and additionally recorded when the image data are recorded in the optical recording medium in a video format.

### CROSS-REFERENCE TO RELATED APPLICATIONS

This application claims the benefit of priority under 35 USC §119(a) of Korean Patent Application No. 2004-13070 filed Feb. 26, 2004, in the Korean Intellectual Property Office, entitled DATA RECORDING CONTROL METHOD CAPABLE OF ADDING PLAYLIST DURING RECORDING OF DATA IN VIDEO FORMAT IN OPTICAL RECORDING MEDIUM the entire contents of which are hereby incorporated by reference.

### BACKGROUND OF THE INVENTION

1. Field of the Invention

The present invention relates to a data recording control method for use with an optical recording medium. More particularly, the present invention relates to a data recording control method capable of adding a playlist in accordance with the settings provided by a user when the data is recorded onto an optical recording medium in a video format.

2. Description of the Related Art

Optical recording media can be classified as reproducing-only, such as Compact Disk—Read Only Memory (CD-ROM) and Digital Video disk-ROM (DVD-ROM), a one-time writable media such as CD±Recordable (CD±R) and DVD±R, and re-recordable media such as CD±Rewritable (CD±RW), DVD±RW and DVD-RAM.

Data can be recorded in a video record format to the DVD±RW and DVD-RAM. The user may edit the order of titles recorded on the optical recording medium as desired, and generate a playlist of the titles (edited or otherwise). In addition, the playlist itself can be recorded onto the optical recording medium. Accordingly, the titles can be reproduced from the optical recording medium according to the playlist made by the user.

When data is recorded in a video format onto a DVD±R, however, a playlist can not be generated. A user can not alter the order of the recorded data once it is recorded on a DVD±R. Data can only be reproduced in the order it was recorded initially. The same shortcoming is also experienced in recording data onto a DVD±RW and DVD-RAM in video format instead of video record format.

Therefore, a playlist may not be recorded when data is recorded on the optical recording medium in the video format. Accordingly, in order to edit certain scenes or intervals of the recorded images and reproduce the edited data, the user must record the edited data to the optical recording medium under a separate title, (in a video record format) which is waste of recording space of the optical recording medium.

### SUMMARY OF THE INVENTION

Accordingly, the present invention has been made to solve the problems discussed above, other problems not mentioned and to provide additional advantages as well. An object of the present invention is to provide a recording control method for use in recording image data onto an optical recording media in a video format that is capable of additionally recording to the optical recording medium a playlist regarding edited information on certain desired scenes or intervals of the recorded images.

The above aspects and/or other features of the present invention are achieved by providing a record control method for use when image data is recorded onto an optical recording medium in a video format, the record control method comprising recording the image data onto the optical recording medium in the unit of title, designating a predetermined interval in the recorded title, constructing a playlist with information about the designated predetermined interval, and recording the constructed playlist in a predetermined location of the optical recording medium.

An object of the present invention is to provide a method for record control wherein the predetermined interval can be designated by setting a beginning point and an ending point of the title. The title can be reproduced, and while viewing the reproduced title, a user can set the beginning and the ending points, respectively. Furthermore, when there are a plurality of titles recorded in the optical recording medium, a certain location of one title can be designated as the beginning point, and a certain location of another title can be designated as the ending point. When there are a plurality of titles recorded in the optical recording medium, the predetermined interval can be designated based on the unit of title.

Other embodiments of the present invention further provide that the step of deleting the constructed playlist can be further provided.

The deleted playlist preferably is not be recorded in the predetermined location of the optical recording medium.

According to an embodiment of the present invention, when there are a plurality of playlists constructed, the playlist deleting step comprises the steps of displaying a list of the constructed playlists, selecting, with reference to the displayed list, one for deletion among the playlists, and deleting the selected playlist. The playlist can include at least one of the information comprising a name of the playlist and a date of constructing the playlist.

When there are a plurality of playlists constructed, the plurality of playlists can be tabulated into a playlist table, and the playlist table can be recorded in the predetermined location of the optical recording medium. The playlist table can further include a header which contains information about the playlist table.

According to another embodiment of the present invention, when one of either a playlist table construct command, an optical recording medium eject command, or a power-off command is received, the playlist table can be generated, and recorded in the predetermined location of the optical recording medium. Also, the information about the predetermined location recording therein the playlist can be recorded in the optical recording medium. When the optical recording medium is loaded, the playlist can be read out with reference to the information about the predetermined location, or read out using the title of the playlist. The playlist can be recorded under a separate title, and the title can be recorded in the predetermined location of the optical recording medium.

### BRIEF DESCRIPTION OF THE DRAWINGS

The above aspects and features of the present invention will be more apparent by describing certain embodiments of the present invention with reference to the accompanying drawings, in which:

FIG. 1 is a block diagram of an optical recording and reproducing apparatus for a recording control method according to an embodiment of the present invention;

FIG. 2 is a flowchart illustrating a recording control method for additionally recording a playlist of data when the data is recorded on an optical recording medium in a video format according to an embodiment of the present invention;

FIG. 3 is a detailed flowchart illustrating the process of making the playlist of FIG. 2;

FIG. 4 is a view provided for explaining of the playlist;

FIGS. 5A and 5B are views provided for explaining of the process of designating a beginning and ending of FIG. 3;

FIGS. 6A and 6B are views provided for explaining of the playlist generated in the playlist generating process of FIG. 3;

FIG. 7 is a detailed flowchart of the playlist deleting process of FIG. 2;

FIG. 8 is a view provided for explaining of the playlist which is indicated in the playlist indicating process of FIG. 7;

FIG. 9 is a view provided for explaining of the playlist table recording process of FIG. 2; and

FIG. 10 is a view illustrating an example in which the playlist table is recorded in the optical recording medium under one title.

### DETAILED DESCRIPTION OF THE EXEMPLARY EMBODIMENTS

Certain embodiments of the present invention will be described in greater detail with reference to the accompanying drawings; in which like numbers are used to refer to like features and structures. The matters defined in the description such as a detailed construction and elements are provided to assist in a comprehensive understanding of the invention. Thus, it is apparent that the present invention can be carried out without those defined matters. Also, well-known functions or constructions are not described in detail for purposes of conciseness and clarity.

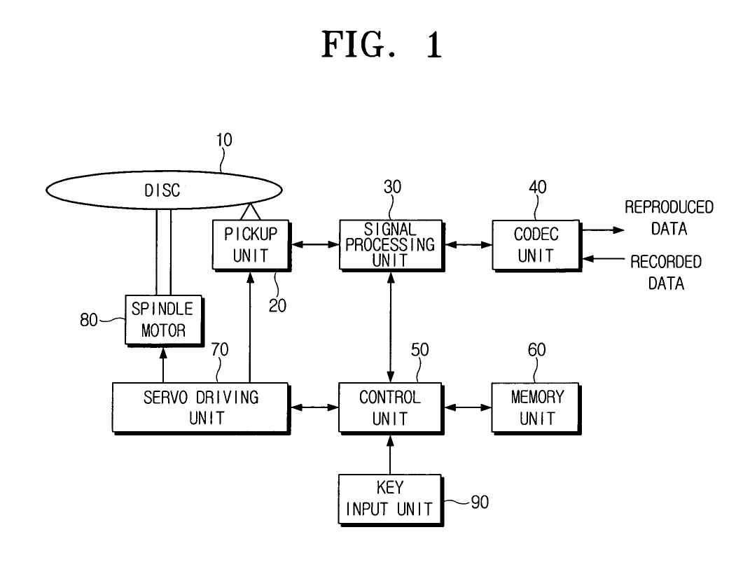

FIG. 1 is a block diagram of an optical recording and reproducing apparatus for a recording control method according to an embodiment of the present invention. Referring to FIG. 1, the optical recording and reproducing apparatus comprises a spindle motor 80 for rotating a disc 10, a pickup unit 20 for reading information from the disc 10 and recording information on the disc 10, a signal processing unit 30 for signal-processing (e.g. error correction), a CODEC unit 40 for data compression/decompression, and a controlling unit 50 for controlling recording and reproducing operation. The optical recording and reproducing apparatus further comprises a memory unit 60, a servo driving unit 70 and a key input unit 90. If the recording and reproducing apparatus is part of, or connected to a computer for use, the CODEC unit 40 can be installed inside the computer main body.

The process of reproducing data will now be described briefly. Data recorded on the disc 10 is read by the pickup unit 20 and fed to the signal processing unit 30. The signal processing unit 30 then performs certain processes such as error correction, and feeds the data to the CODEC unit 40. The CODEC unit 40 decompresses the compressed data and outputs the uncompressed data.

The process of recording data will now be described briefly. When data for recording is received, the CODEC unit 40 compresses the data and supplies the compressed data to the signal processing unit 30. The signal processing unit 30 performs necessary signal processing operations and supplies the processed data to the pickup unit 20. The pickup unit 20 irradiates one or more laser beams onto the disc 10 in accordance with the input signal, and thereby records the data. Both the data recording and reproducing processes described above are performed under the control of the controlling unit 50.

According to an embodiment of the present invention, the recording control method directs the controlling unit 50 to confirm whether there is a playlist table recorded in the disc 10 as loaded, and if so, to read out the playlist table and store it in the memory unit 60. Upon receipt of playlist record command, the controlling unit 50 generates a playlist in accordance with predetermined settings, and stores the playlist in the memory unit 60. When there is a playlist delete command input, the controlling unit 50 deletes the selected playlist from the memory unit 60. When a playlist table record command, disc eject command or power-off command is received, the controlling unit 50 generates the playlist table using the playlists stored in the memory unit 60, and records the generated playlist table at a certain location on the disc 10.

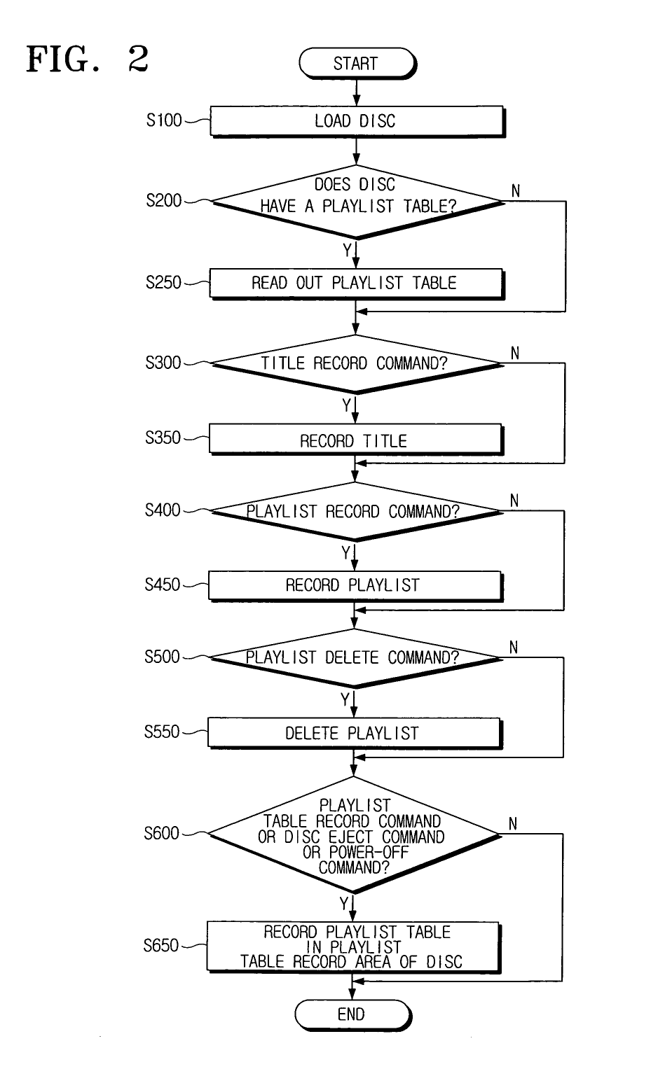

The recording control method according to an embodiment of the present invention will be described with reference to FIG. 2 for additionally recording a playlist when the data is recorded onto the optical recording medium in a video format. The recording control method according to an embodiment of the present invention comprises the steps of loading a disc 10 (step S100), determining whether there is a playlist table recorded in the disc 10 (decision step S200), and if so, (“Yes” path from decision step S200), reading out and storing the playlist table in the memory unit 60 (step S250). If the disk 10 does not have a playlist table (“No” path from decision step S200), the method proceeds to decision step S300. The playlist table is recorded in the playlist table area that is designated in the data record area, and the playlist table area can be located anywhere within the data record area. The playlist table and related information will be described in greater detail below.

If a title record command is received from the user (“Yes” path from decision step S300), data is recorded in the disc 10 in the unit of title (step S350). Accordingly, a recording process is performed in which the data is compressed in the CODEC unit 40, processed as necessary in the signal processing unit 30, and recorded by the pickup unit 20 onto the disc 10. If a title record command is not received from the user (“No” path from decision step S300), the method proceeds to decision step S400.

If a playlist record command is received from the user (“Yes” path from decision step S400), a playlist is generated in accordance with the predetermined settings by the user and stored in the memory unit 60 (step S450). The ‘playlist record command’ directs the controller 50 to record a playlist about the information on scenes or intervals selected and edited by the user from the images recorded in the disc. If a playlist record command is not received from the user (“No” path from decision step S400), the method proceeds to decision step S500.

If a playlist delete command is received from the user (“Yes” path from decision step S500), the playlist selected by the user is deleted from the memory unit 60 (step S550). The ‘playlist delete command’ directs the controller 50 to delete a playlist that is generated and stored in advance in the memory unit 60. If a playlist delete command is not received “No” path from decision step S500), the method proceeds to decision step S600.

In decision step S600, the controller 50 determines whether a playlist table record command, disc eject command, or power-off command has been generated by the user (step S600). If any of these commands listed in decision step S600 are received (“Yes” path from decision step S600), the playlists stored in the memory unit 60 are read out, added with headers and tabulated into a playlist table. The playlist table is recorded in a predetermined location of the disc 10 for playlist table (step S650). Once recorded, the playlist table can be detected in the operation of S200 when the disc 10 is loaded. If neither a playlist table record command, disc eject command, or power-off command has been received (“No” path from decision step S600), the method terminates.

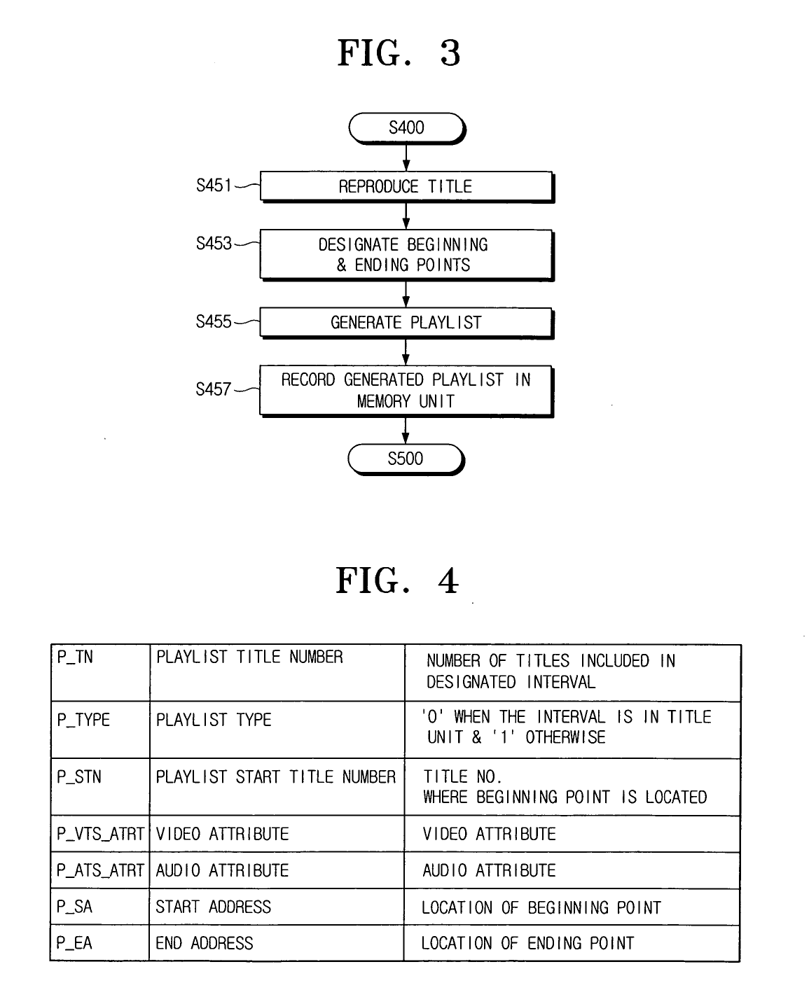

The playlist recording step S450 of FIG. 2 will be described in greater detail with reference to FIG. 3. In the playlist recording step, titles recorded in the disc 10 are reproduced (step S451), and then the user sets a beginning point and ending point so as to set a certain interval for a playlist (step S453). Accordingly, playlists are generated with respect to the set interval (step S455), and recorded in the memory unit 60 (step S457).

The process of setting the beginning and ending of the playlist interval will now be described in greater detail. While viewing the titles currently being reproduced, the user finds the beginning of the desired scene or interval, and presses the ‘Start’ button (not shown) provided to the key input unit 90 to designate the beginning point. When the interval or scene ends, the user then presses an ‘End’ button (also not shown) of the key input unit 90 to designate the ending point.

The playlist generated during operation of step S455 is also recorded with the information on the interval designated in the operation S453, which is illustrated in FIG. 4.

FIG. 4 illustrates a table of playlist variables and each variable's definition and description. The variable ‘P_TN’ (Playlist title number) indicates the number of titles contained in the user-designated interval. The variable ‘P_Type’ (Playlist type) indicates information on the type of the user-designated interval. The variable ‘P_STN’ (Playlist start title number) indicates the title number located in the beginning point. The variable ‘P_VTS_ATRT’ (Video attribute) indicates information on the video attributes. ‘P_SA’ (Start address) indicates the location of the beginning point such as address on the disc 10, and the variable ‘P_EA’ (End address) indicates the location of the ending point such as address of the disc 10.

When the interval is designated based on the unit of title, ‘P_Type’ is ‘0’, and otherwise, ‘P_Type’ is ‘1’. If the interval is designated based on the unit of title, it means that the interval extends from the beginning of the first title to the last part of the third title and the interval is designated on the first, the second and the third title, which is identical to that previously described. When the interval is designated according to the title unit, ‘P_SA’ and ‘P_EA’ are unnecessary. The other cases can include, for example, when the interval begins from the middle of the first title to the middle of the third title. In this case, ‘P_SA’ and ‘P_EA’ are necessary.

Values for the variables ‘P_VTS_ATRT’ and ‘P_ATS_ATRT’ are not necessarily required for the playlist. Accordingly, ‘P_VTS_ATRT’ and ‘P_ATS_ATRT’ can be used for any other information that is related with the playlist. For example, ‘P_VTS_ATRT’ and ‘P_ATS_ATRT’ can be used for recording information such as name of the playlist, date of recording the playlist, or play time of the designated interval.

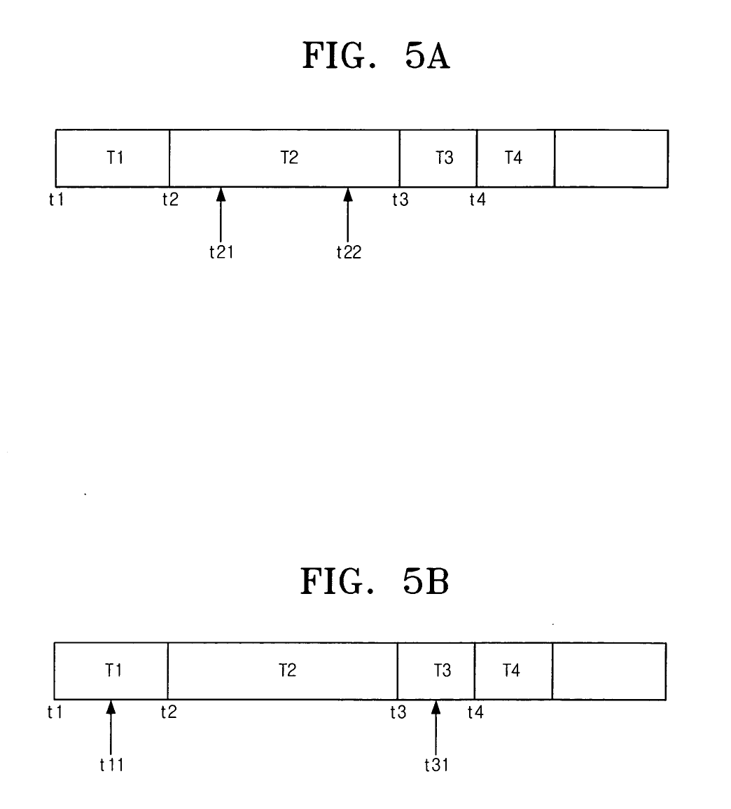

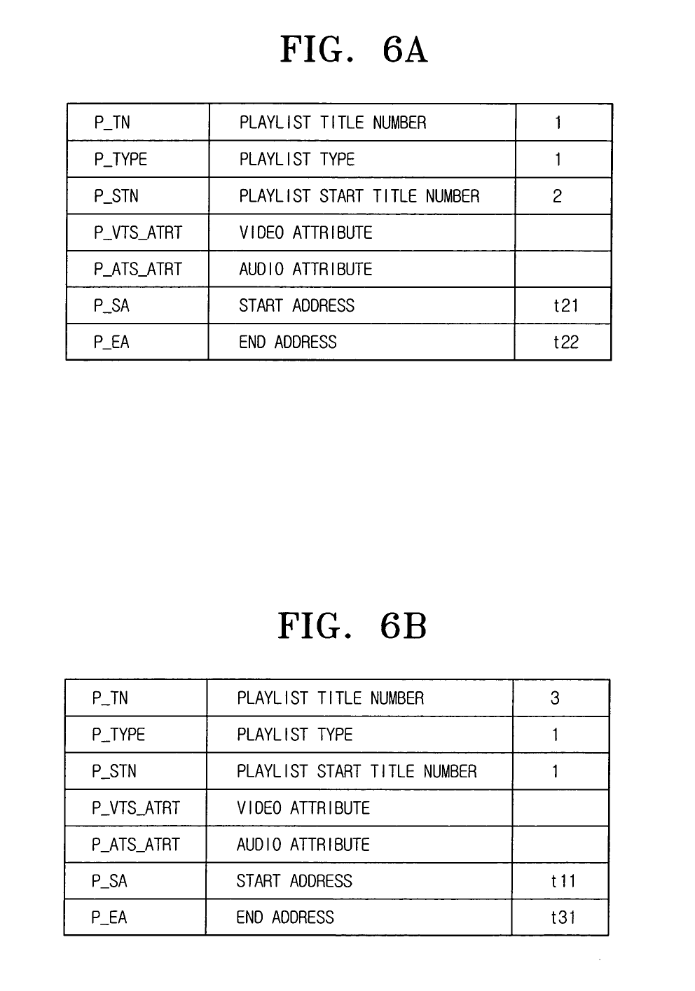

Detailed examples of the playlist that is generated in operation of step S455 of the method displayed in FIG. 3 based on the interval designated by the user during the operation of step S453 will now be described in greater detail. Referring to FIG. 5A, the user designates location ‘t21’ of the second title T2 as the beginning point, and designates location ‘t22’ of the second title T2 as the ending point. FIG. 6A shows the playlist generated when the interval is designated as shown in FIG. 5A.

Because one title T2 is included in the user-designated interval t21˜t22, ‘P_TN’ is ‘1’, and because the user-designated interval is not in the title unit, ‘P_Type’ is ‘1’. Because the second title is on the beginning point, ‘P_STN’ is ‘2’, and because ‘t21’ and ‘t22’ are beginning and ending points of the interval, respectively, ‘P_SA’ and ‘P_EA’ are ‘t21’ and ‘t22’, respectively.

Referring now to FIG. 5B, another example of a user designating beginning and ending points is shown. In FIG. 5B, the user has designated location ‘t11’ of the first title T1 as the beginning point, and location ‘t31‘of the third title ’ T3′ as the ending point of the interval. FIG. 6B shows the playlist generated with respect to the interval designated as shown in FIG. 5B. Because three titles T1, T2, T3 are included in the user-designated interval t11˜t31’, ‘P_TN’ is ‘3’, and because the designated interval is not in the title unit, ‘P_Type’ is ‘1’. Additionally, because the beginning point is located in the first title, ‘P_STN’ is ‘1’, and because ‘t11’ and ‘t31’ are the beginning and ending points, ‘P_SA’ and ‘P_EA’ are ‘t11’ and ‘t31’, respectively.

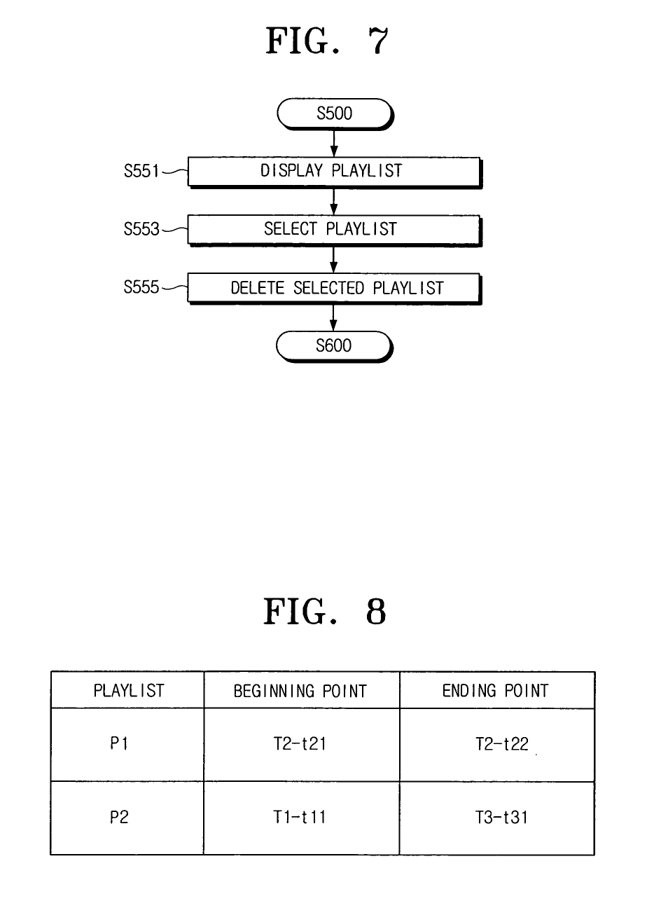

Operation of step s550 for deleting a playlist, as shown in FIG. 2, will now be described in reference to FIG. 7. In the playlist deletion step, playlists stored in the memory unit 60 are displayed in step S551. The user then selects one among the displayed playlists in step S553, and the selected playlist is deleted from the memory unit 60 in step S555. The playlist (P1) as shown in FIG. 6A and the playlist (P2) as shown in FIG. 6B can be stored in the memory unit 60 and can generate a list as shown in FIG. 8. These are the playlists that are displayed in the playlist display step (S551).

When the user selects one of the displayed playlists and inputs a reproducing command, the optical recording and reproducing apparatus reproduces the selected interval using the information recorded in the playlist. As a result, the user can view the scene of the designated intervals of the playlist. After viewing the scene of the designated intervals of the playlist, the user selects a playlist and inputs a delete command with respect to the selected playlist. Accordingly, the selected playlist is deleted from the memory unit 60.

In the deletion of the playlist, the user may not necessarily view the scene of the designated intervals of the playlist. The user can directly select a playlist from the list of playlists as shown in FIG. 8 and input a delete command with respect to the selected playlist. Thus, it is possible to delete the playlist from the memory unit 60.

The playlist table recording step (S650) of FIG. 2 will now be described in greater detail. The playlist table recording step (S650) is also performed before ejection of the disc 10 and prior to powering down the optical recording and reproducing apparatus. This prevents information loss and allows the playlist to be re-used afterward.

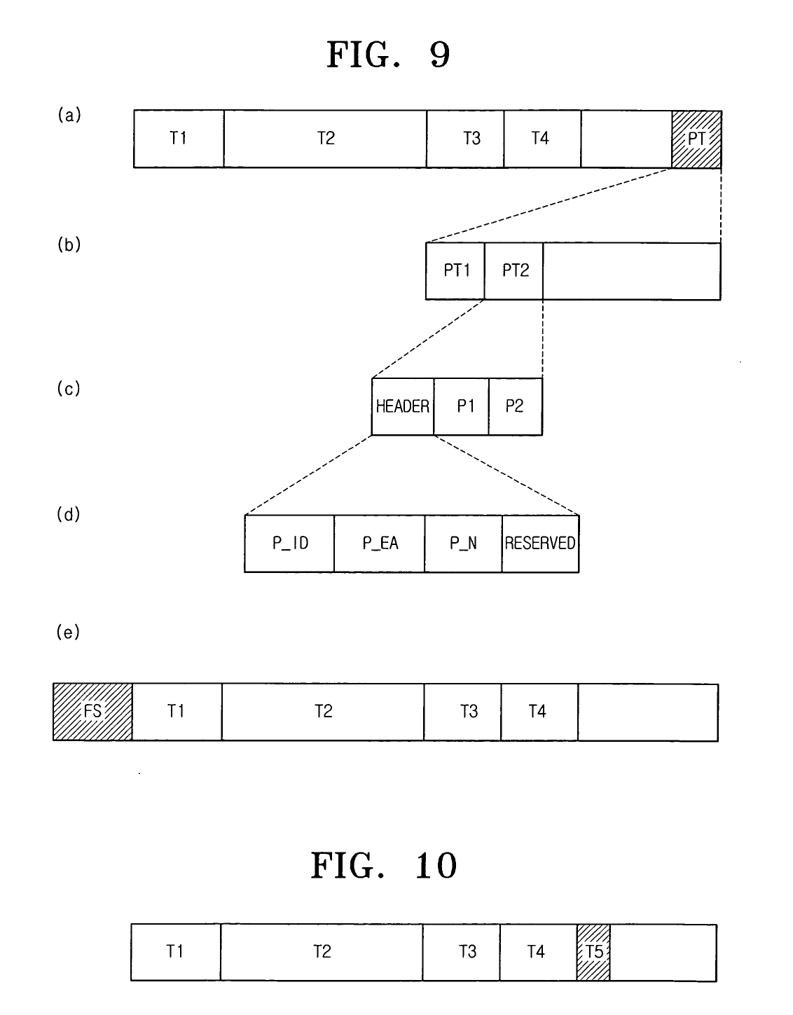

Recording of the playlist table will now be described. The control unit 50 reads out playlists from the memory unit 60, arranges the read playlists in sequence, and add headers to generate a table of playlists. The control unit 50 then records the generated playlist table in a predetermined location of the disc 10. Referring to FIG. 9(a), the last part of the data record area of the disc 10 is allocated as a playlist table record area PT so that the playlist table can be recorded in the area PT. This is in consideration that the titles T1, T2, T3, . . . are recorded from the beginning part of the data record area. As one skilled in the art can appreciate, however, this is an exemplary case, and therefore, the playlist table record area PT can be located anywhere of the data record area.

When the user newly records a playlist or deletes an existing one, a new playlist table is constructed and recorded in the playlist table record area PT whenever a record/disc-eject/power-off command is received. Because the playlist table cannot be deleted once it is recorded in the DVD±R disc, a newly-recorded playlist table (such as ‘PT2’ of FIG. 9B) is sequentially recorded next to the location where the previously-recorded playlist table such as ‘PT1’ of FIG. 9B was recorded.

When reading out the playlist table in operation of step S250, the most-recently recorded playlist table is read out. To accomplish this, the step S250 reads out the playlist table that is recorded in the last part of the playlist table record area PT. For example, when there are two playlist tables PT1, PT2 recorded in the playlist table record area PT, the second playlist table PT2 is read out.

As shown in FIG. 9(c), the playlist table lists the playlists P1, P2 of the memory unit 60 in sequence, and adds headers to the playlists P1, P2. Referring to FIG. 9D, the header includes a ‘P_ID’ (Playlist table ID) variable indicating a playlist table, a ‘P_EA’ (Playlist table end address) variable indicating the address of the last part of the playlist table to provide information about the total length of the playlist table, and a ‘P_N’ (Playlist number) variable indicating the total numbers of the playlists included in the playlist table. Recording the playlist table in the file system area ‘FS’ (see FIG. 9(e)) is possible with respect to the DVD±RW because it is re-recordable.

Finalizing a playlist table-recorded disc will be now described in greater detail. In order to finalize the disc, information notifying the presence of playlist table recorded in the disc (e.g., ‘1’ for presence, and ‘0’ for absence of the playlist table in the disc 10), and information about the location where the playlist table is recorded, such as the beginning address of ‘PT2’ in FIG. 9(b) is recorded in the video manager information area (VMGI) reserved area. In the disc finalization, it is possible that playlist table presence and location information are recorded in an area other than the VMGI reserved area.

In the case of DVD±RW, when the playlist table is recorded in the file system area FS, the recorded information is moved to the playlist table recording area and the playlist table presence and location information are recorded in the VMGI reserved area. Although a particular example of a method for finalization has been described above by way of illustration, methods other than the above-described method can also be utilized, as one skilled in the art of the present invention can appreciate. For example, the playlist table can be generated into a title and recorded. In this case, the playlist table-recorded title can be recorded after the previously-recorded titles.

FIG. 10 shows an example in which the playlist table is generated into a fifth title ‘T5’ and recorded next to the previously-recorded titles T1, T2, T3, T4. The fifth title T5 may be reproduced by using either navigation commands or link commands.

As described above, according to the embodiments of the present invention, a playlist can be generated and recorded when recording image data onto optical recording medium in video format. Accordingly, a certain scene or interval can be edited for reproducing, by using the recorded playlist. Because the playlist requires a relatively small amount of space, space can be more efficiently utilized, when compared to the conventional case in which image data of a certain scene or interval are recorded in the optical recording medium under separate titles.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A record control method for use when image data is recorded in an optical recording medium in a video format, the record control method comprising the steps of:
recording the image data onto the optical recording medium in the unit of a title;
designating a predetermined interval in the recorded title;
constructing a playlist with information about the designated predetermined interval; and
recording the constructed playlist at a predetermined location of the optical recording medium.

2. The record control method of claim 1, wherein the step of designating a predetermined interval comprises:
setting a beginning point and an ending point of the title.

3. The record control method of claim 1, wherein the step of designating a predetermined interval comprises
reproducing a title; and
setting a beginning and an ending points, respectively while viewing the reproduced title.

4. The record control method of claim 1, wherein the step of designating a predetermined interval comprises:
setting a certain location of one title as a beginning point, and a certain location of another title as an ending point.

5. The record control method of claim 1, wherein the predetermined interval can be designated based on the unit of title.

6. The record control method of claim 1, further comprising:
deleting the constructed playlist.

7. The record control method of claim 6, wherein the deleted playlist is not recorded at the predetermined location of the optical recording medium.

8. The record control method of claim 1, further comprising:
constructing a plurality of playlists with information about the designated predetermined interval;
displaying a list of the constructed playlists;
selecting, with reference to the displayed list, one for deletion among the playlists; and
deleting the selected playlist.

9. The record control method of claim 1, wherein the playlist includes at least one of the information comprising a name of the playlist and a date of constructing the playlist.

10. The record control method of claim 1, further comprising:
constructing a plurality of playlists with information about the designated predetermined interval;
tabulating the plurality of playlists into a playlist table; and
recording the playlist table at the predetermined location of the optical recording medium.

11. The record control method of claim 10, wherein the playlist table comprises a header that contains information about the playlist table.

12. The record control method of claim 10, further comprising:
generating a playlist table when one of either a playlist table construct command, an optical recording medium eject command, or a power-off command is received; and
recording the playlist table at the predetermined location of the optical recording medium.

13. The record control method of claim 1, wherein the information about the predetermined location recording therein the playlist, is recorded in the optical recording medium, and
in the loading of the optical recording medium, the playlist is read out with reference to the information about the predetermined location.

14. The record control method of claim 1, further comprising:
recording the constructed playlist under a separate title at the predetermined location of the optical recording medium.

15. The record control method of claim 14, further comprising:
reading the constructed playlist out using the title of the playlist recorded in the optical recording medium.
